(19) United States
(12) Patent Application Publication
(10) Pub. No.: US 2008/0174403 A1
(43) Pub. Date: Jul. 24, 2008

(54) Multiple wireless access points for wireless locksets

(76) Inventors: Michael Wolpert, Westlake Village, CA (US); Ray Bernard, Lake Forest, CA (US); Donald E. Sturgis, Claremont, CA (US); David Kimmich, Lakeport, CA (US)

Correspondence Address: CHRISTIE, PARKER & HALE, LLP, PO BOX 7068, PASADENA, CA, 91109-7068, US

(21) Appl. No.: 11/704,869

(22) Filed: Feb. 9, 2007

Related U.S. Application Data
(60) Provisional application No. 60/772,176, filed on Feb. 9, 2006.
(60) Provisional application No. 60/814,129, filed on Jun. 16, 2006.

(51) Int. Cl. G05B 19/00

(52) U.S. Cl. 340/5.61

(57) ABSTRACT

A wireless access control system. In some embodiments, the system includes: a switch; a plurality of wireless access points coupled to the switch and including a first wireless access point including a first wireless transceiver and a second wireless access point including a second wireless transceiver, the first wireless transceiver adapted to define a first coverage area, and the second wireless transceiver adapted to define a second coverage area; and a wireless device located within the second coverage area and having an identity code adapted to uniquely and wirelessly identify the wireless device to the plurality of wireless access points. The wireless device rates the quality of the connection to the access control computer system and the wireless access points and downloads access control information from the first or second wireless access point based on the connection quality ratings.

### CROSS-REFERENCE TO RELATED APPLICATION(S)

This application claims priority to and the benefit of U.S. Provisional Patent Application Ser. No. 60/772,176, filed on Feb. 9, 2006, and U.S. Provisional Patent Application Ser. No. 60/814,129, filed on Jun. 16, 2006, the entire contents of which are incorporated herein by reference.

### FIELD OF THE INVENTION

The invention relates generally to wireless access control systems and, more particularly, to systems and methods for controlling and/or providing multiple wireless access points for wireless locksets.

### BACKGROUND OF THE INVENTION

It is known that a lockset (e.g., keypad, card reader, etc.) on a door can be used to control access to a secure region. Known wired lockets are expensive and complex to install because of a need to physically connect each lockset to a remote device by wiring. As such, there is a need for a more cost-effective and versatile access control system, such as a wireless access control system.

### SUMMARY OF THE INVENTION

Aspects of the present invention respectively are directed to a wireless access control system and methods of providing and/or controlling the same.

In an embodiment of the present invention, a wireless access control system includes: a switch; a plurality of wireless access points coupled to the switch and including a first wireless access point including a first wireless transceiver and a second wireless access point including a second wireless transceiver, the first wireless transceiver adapted to define a first coverage area, and the second wireless transceiver adapted to define a second coverage area; and a wireless device located within the first and second coverage area and having an identity code adapted to uniquely and wirelessly identify the wireless device to the plurality of wireless access points. The wireless device rates the quality of the connection to the access control computer system and the wireless access points and downloads access control information from the first or second wireless access point based on the connection quality ratings.

The switch may be adapted to allow the wireless device to communicate wirelessly with the first wireless access point when the wireless device is located within the first coverage area.

The first wireless access point may be a primary access point of the wireless device.

The switch may be adapted to allow the wireless device to communicate wirelessly with the first wireless access point while the wireless device is moved from the second coverage area to the first coverage area.

The wireless device may be a wireless lockset.

The wireless lockset may be a self-contained battery-operated assembly adapted to be mounted to a door.

The self-contained battery-operated assembly may include a latching solenoid adapted to remain in one of a locked position or an unlocked position in an unpowered state.

The wireless lockset may include at least one of a magnetic stripe card reader, a smart card reader, or a proximity card reader.

The plurality of wireless access points may further include a third wireless access point including a third wireless transceiver adapted to define a third coverage area, the third coverage area overlapping a portion of the first coverage area and a portion of the second coverage area. The wireless device may also be located within the third coverage area.

The switch may be coupled with each of the wireless access points via an Ethernet cable.

The wireless device may be a wireless portal controller coupled with at least one of an external magnetic stripe card reader or an external proximity card reader.

The wireless device may be a wireless input/output module coupled with a plurality of monitor contacts of a door, the wireless input/out module being adapted to notify one of the wireless access points upon closing and opening of the door.

In other embodiments of the present invention, a wireless access control system includes: a switch; a plurality of wireless access points coupled to the switch and including a first wireless access point including a first wireless transceiver and a second wireless access point including a second wireless transceiver, the first wireless transceiver adapted to define a first coverage area, and the second wireless transceiver adapted to define a second coverage area; and a wireless device located within the second coverage area and having an identity code adapted to uniquely and wirelessly identify the wireless device to the plurality of wireless access points. The switch is adapted to allow the wireless device to communicate wirelessly with the first wireless access point when the wireless device is located within the first coverage area.

In other embodiments of the present invention, a wireless access control system includes: a switch; a plurality of wireless access points coupled to the switch and including a first wireless access point including a first wireless transceiver and a second wireless access point including a second wireless transceiver, the first wireless transceiver adapted to define a first coverage area, and the second wireless transceiver adapted to define a second coverage area; and a wireless device located within the second coverage area and having an identity code adapted to uniquely and wirelessly identify the wireless device to the plurality of wireless access points. The switch is adapted to allow the wireless device to communicate wirelessly with the first wireless access point while the wireless device is moved from the second coverage area to the first coverage area.

In other embodiments of the present invention, a method is for operating a wireless access control system including: a switch; a plurality of wireless access points coupled to the switch and including a first wireless access point including a first wireless transceiver and a second wireless access point including a second wireless transceiver, the first wireless transceiver adapted to define a first coverage area, and the second wireless transceiver adapted to define a second coverage area overlapping a portion of the first coverage area; and a wireless device located within the overlapped portion of the first coverage area and having an identity code adapted to uniquely and wirelessly identify the wireless device to the plurality of wireless access points. The method includes: receiving at the first wireless access point a first signal from the wireless device; receiving at the second wireless access point a second signal from the wireless device; measuring at the first wireless access point a first signal strength of the first signal; measuring at the second wireless access point a second signal strength of the second signal; sending the first signal strength by the first wireless access point to the second wireless access point; sending the second signal strength by the second wireless access point to the first wireless access point; determining at the first wireless access point and the second wireless access point a stronger signal strength of the first signal strength and the second signal strength; selecting, if the first signal strength is determined to be the stronger signal strength, (e.g., by the first wireless access point) the first wireless access point as a primary access point corresponding to the wireless device; and selecting, if the second signal strength is determined to be the stronger signal strength, (e.g., by the second wireless access point) the second wireless access point as a primary access point corresponding to the wireless device.

In yet other embodiments of the present invention, a method is for operating a wireless access control system including: a switch; a plurality of wireless access points coupled to the switch and including a first wireless access point including a first wireless transceiver and a second wireless access point including a second wireless transceiver, the first wireless transceiver adapted to define a first coverage area, and the second wireless transceiver adapted to define a second coverage area overlapping a portion of the first coverage area; and a wireless device located within the overlapped portion of the first coverage area and having an identity code adapted to uniquely and wirelessly identify the wireless device to the plurality of wireless access points. The method includes: receiving at the wireless device a first signal from the first wireless access point; receiving at the wireless device a second signal from the second wireless access point; measuring at the wireless device a first signal strength of the first signal; measuring at the wireless device a second signal strength of the second signal; determining at the wireless device a stronger signal strength of the first signal strength and the second signal strength; selecting, if the first signal strength is determined to be the stronger signal strength, the first wireless access point as a primary access point corresponding to the wireless device; and selecting, if the second signal strength is determined to be the stronger signal strength, the second wireless access point as a primary access point corresponding to the wireless device.

### BRIEF DESCRIPTION OF THE DRAWINGS

The accompanying drawings, together with the specification, illustrate exemplary embodiments of the present invention, and, together with the description, serve to explain the principles of the present invention.

FIG. 1 shows an embodiment of a wireless access control system.

FIG. 2 shows another embodiment of a wireless access control system.

FIG. 3 is a block diagram of a wireless access control system according to an embodiment of the present invention.

FIG. 4 shows the unsecured side of a battery powered wireless lockset of a wireless access control system according to an embodiment of the present invention.

FIG. 4A shows a block diagram of a wireless lockset of a wireless access control system according to an embodiment of the present invention.

FIG. 5 shows a cylindrical lockset of a wireless access control system according to an embodiment of the present invention.

FIG. 6 shows a mortise lockset of a wireless access control system according to an embodiment of the present invention.

FIG. 7 is a block diagram of a wireless portal controller of a wireless access control system according to an embodiment of the present invention.

FIG. 8 is a block diagram of a wireless input/output module of a wireless access control system according to an embodiment of the present invention.

### DETAILED DESCRIPTION OF THE INVENTION

In the following detailed description, certain exemplary embodiments of the present invention are shown and described, by way of illustration. As those skilled in the art would recognize, the described exemplary embodiments may be modified in various ways, all without departing from the spirit or scope of the present invention. Accordingly, the drawings and description are to be regarded as illustrative in nature, rather than restrictive. There may be parts shown in the drawings, or parts not shown in the drawings, that are not discussed in the specification as they are not essential to a complete understanding of the invention.

In the present description, a wireless access control system is referred to as an access control system that utilizes suitable wireless techniques as the communication path to enable one or more wireless access points to send and receive data and commands to and from a multiplicity of wireless locksets (e.g., battery operated wireless locksets). Each of the locksets may contain a magnetic stripe, proximity card reader such as an RFID reader, smart card reader, or other “what you have” detector, a biometric reader or other physical identification (“who you are”) detector, a twelve-key keypad or other input device for entry of knowledge based data or code (what you know”), or some combination of these readers and input devices.

In an embodiment of the present invention, a wireless access point is connected to a Local Area Network (LAN) in order to communicate with a suitable remote device, e.g., a computer on the same LAN. In alternate embodiments, the LAN is either wired (e.g., Ethernet) or wireless (WLAN) (e.g., 802.11g) or a combination of wired and wireless network links. In other embodiments, other types of secure networks are used. The computer can interface with the wireless access point via a web browser, such as Microsoft Internet Explorer, thereby eliminating the need to install any custom software on the computer. In addition, access control software in accordance with an embodiment of the present invention resides in the wireless access point. This access control software should look like and operate like a website so that only minimal training is required to use the system.

The system includes an access control database. The access control database includes entries for each individual that is allowed access by the access control system, each location that is secured by the access control system, and each access point and each lockset in the access control system. Depending on the embodiment, entries for individuals in the access control database may include any of the following information: first and last name, title, access card identification numbers, locations the person has access to, individual locksets the person can unlock, times/days during which the person should have access to the location/lockset, the person's work schedule, and any other parameter that is necessary or helpful to the access control system. Entries for locations may include, for example, which locksets control access to the location and from what other location do the locksets control access.

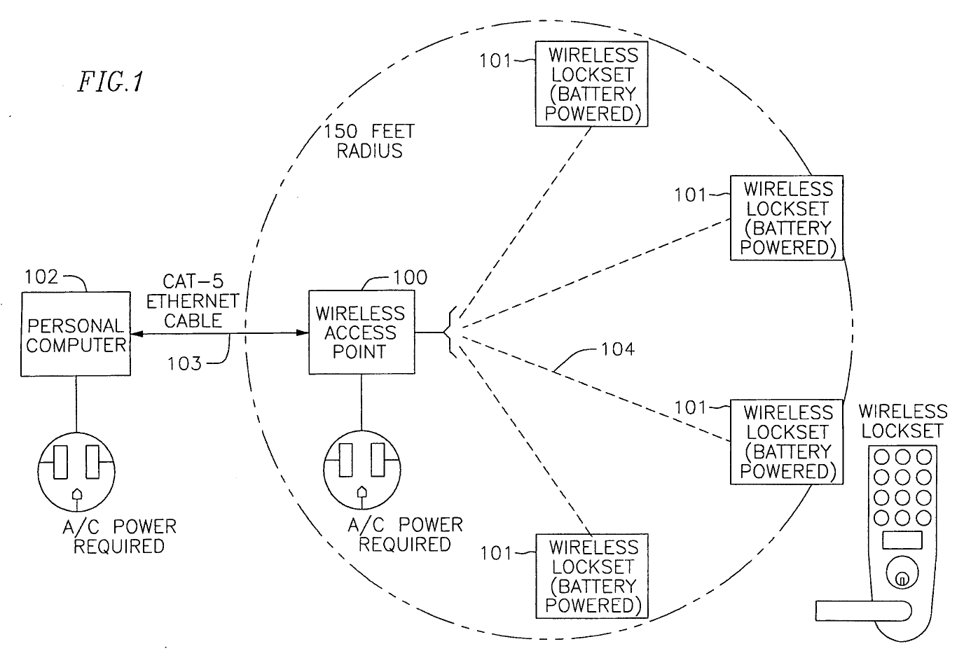

Referring to the embodiment shown in FIG. 1, one strategically located wireless access point 100 can communicate with a plurality of wireless devices 101 (e.g., wireless locksets) through a wireless connection 104. In a preferred embodiment, the wireless data connection 104 is an RF connection that is encrypted with a proprietary encryption code. In other embodiments, the wireless data connection 104 is a known type of wireless data connection, such as 802.11x, or future developed type of wireless connection. The wireless data connection 104 is secured by commercially available encryption, proprietary encryption or other security method. The wireless access point 100 also communicates with other wireless devices (not shown) that are part of the access control system. Additionally, the wireless access points may be connected by conventional wiring to non-wireless locksets or other access control system devices. Alternatively, a wireless portal controller is supplied that provides an interface between legacy locksets and/or access devices. The wireless portal controller communicates with the access point in the same basic way as the wireless access point except that it does not include a locking mechanism. Rather, the wireless portal controller includes an interface connected, typically wired, to the legacy device; the interface receives data received by the legacy device (such as a card reader) and passes it to the wireless portal controller for processing (e.g., making an access decision); the interface then receives access decision instructions from the wireless portal controller and sends those instructions to the legacy device (such as an electronic lock). In the example described of a wireless portal controller, the legacy device may be a unitary device (e.g., combination reader and lockset) or it may consist of separate physical devices (e.g., separate reader and lockset). The wireless access point 100 is connected to a computer 102 that coordinates the access control system by an Ethernet connection 103. Alternatively, the wireless access point 100 may be connected to the computer 102 by any other secure network connection, such as a secure wireless connection, serial connection such as an RS-232 or RS-485 connection. In some embodiments, computer 102 and wireless access point 100 each are connected to wireless transceivers (not shown) through a wired connection and computer 102 and wireless access point 100 communicate using the wireless connection between the wireless transceivers. In some embodiments, the wireless transceivers and the wireless access points are powered using uninterruptible power supplies or other form of temporary power supply in the case of the loss of main power.

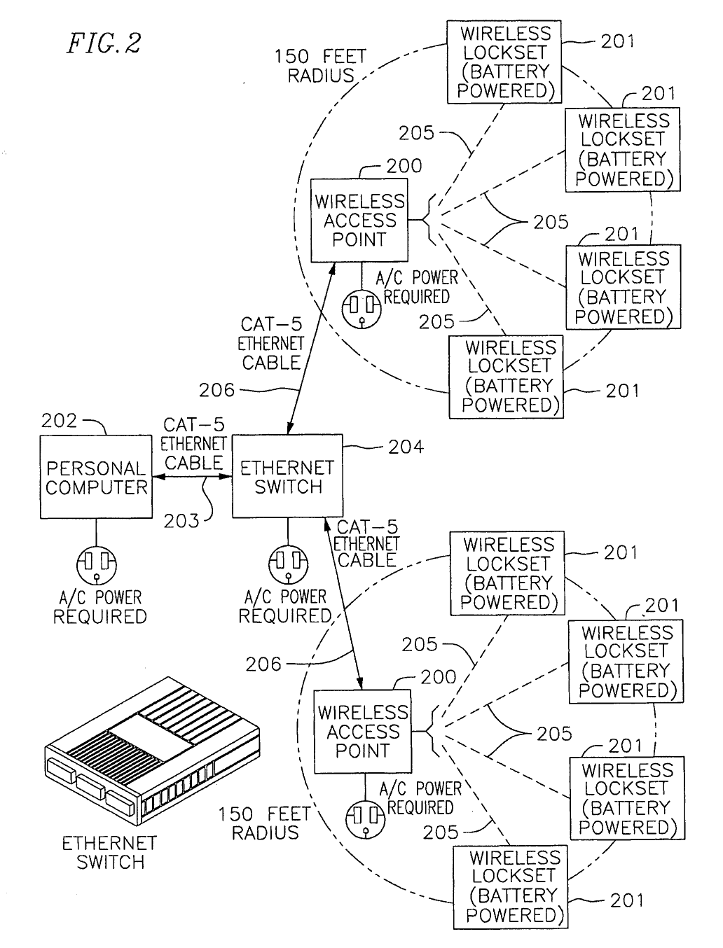

In the embodiment shown in FIG. 2, additional access points 200 are connected to the system, including the coordination computer 202, via a secure network (e.g., commercially available Ethernet switch 204 in the embodiment shown). These additional access points 200 communicate with additional wireless locksets 201 located in other areas of a building.

The designs and implementations of the a) wireless access point 100, 200 and b) wireless lockset 101, 201 are described in more detail below.

In some embodiments, a wireless access point 100, 200 stores all or part of the access control database and utilizes any suitable wireless methods as the communication path to send and receive data and commands to and from a multiplicity of battery operated wireless locksets 101, 201. In some embodiments, the wireless access point 100, 200 communicates with a maximum of 64 wireless locksets 101, 201 within a radius of approximately 150 feet. In other embodiments, the maximum number of wireless locksets 101, 201 is 128 or some higher limit. In many cases, the maximum number of locksets 101, 201 is affected by hardware power, software limitations, wireless bandwidth limitations, or other system or environmental constraints. Also, in other embodiments, the range between the access point 100, 200 and the locksets 101, 201 is 750 feet. In still other embodiments, the range between the access point 100, 200 and the locksets 101, 201 is higher than 750 feet, depending on factors such as wall and/or another obstruction density, new or different wireless technology, interference levels, and other system and environmental factors.

Access control software resides in the wireless access point 100, 200 and can be connected to a Local Area Network (LAN) to communicate with any computer on the same LAN. In some embodiments, this software interfaces with a computer through a web browser which eliminates the need for installing any custom software on the computer.

This software feels, looks, and operates like a website so that only minimal training is required to use the system. A protected password or any other security measure can be used to prohibit unauthorized access to the data. The access control software provides the ability to access the entries in the access control database, such as identifying each cardholder by first and last name, the individual wireless locksets 101, 201 and all other parameters by user defined names.

Wireless lockset door actions and cardholder transactions (e.g., who went where when) can be available by the access point 100, 200 for generating various reports. The access point 100, 200 stores a plurality of transactions received from the locksets 101, 201. The oldest transactions can be overwritten when the transaction storage becomes full. The software of the access point 100, 200 should be capable of printing listings of all suitable database files, e.g., cardholder files, lockset files, etc.

In addition, as described below, the wireless access point 100, 200 can store a plurality of cardholder records and distribute these records to the appropriate wireless locksets as required. As such, the access point 100, 200 operates in concert with the wireless locksets to control access of secure regions.

In some embodiments of the present invention, the design of a plurality of wireless access points 200 enables multiple access points to operate in the same system. In some embodiments, this design accomplishes its task by identifying one access point as the master and the others as slaves. That is, an operator, via the browser, can communicate with the master only. The master downloads the access control database files to the slaves through an Ethernet switch 204 as depicted in FIG. 2 or possibly via the wireless network when wireless access points 200 are within wireless range of each other. The slaves then send all lockset door actions and cardholder transactions received from their communicating wireless locksets 201 to the master access point.

In an alternate embodiment, the computer 202 acts as the master and all of the access points 200 act as slaves to the computer 202. In other embodiments, one of the access points 200 acts as the master with respect to some functionality (e.g., coordination of communication between wireless devices 201 in range of multiple access points 200, discussed below) and the computer 202 acts as the master with respect to some other functionality (e.g., central storage and distribution of access control database information). In yet other embodiments, the access points 200 operate in a peer-to-peer arrangement with the computer 202 managing communication with operators and assisting coordination of the access points 200.

In some embodiments of the present invention, multiple access points 200 can operate in an adaptive mode. That is, the access points 200 automatically compensate for changes in the wireless environment by sampling the signal strength from each lockset 201. If two access points 200 are receiving signals from the same lockset 201, the access point 200 receiving the stronger signal makes it a part of its lockset list and informs the other access point 200 of its action. This technique will help simplify the system installation since it informs the installer of communication problems. Using this information the installer may be able to relocate a wireless access point 200 to acquire stronger signals from some locksets.

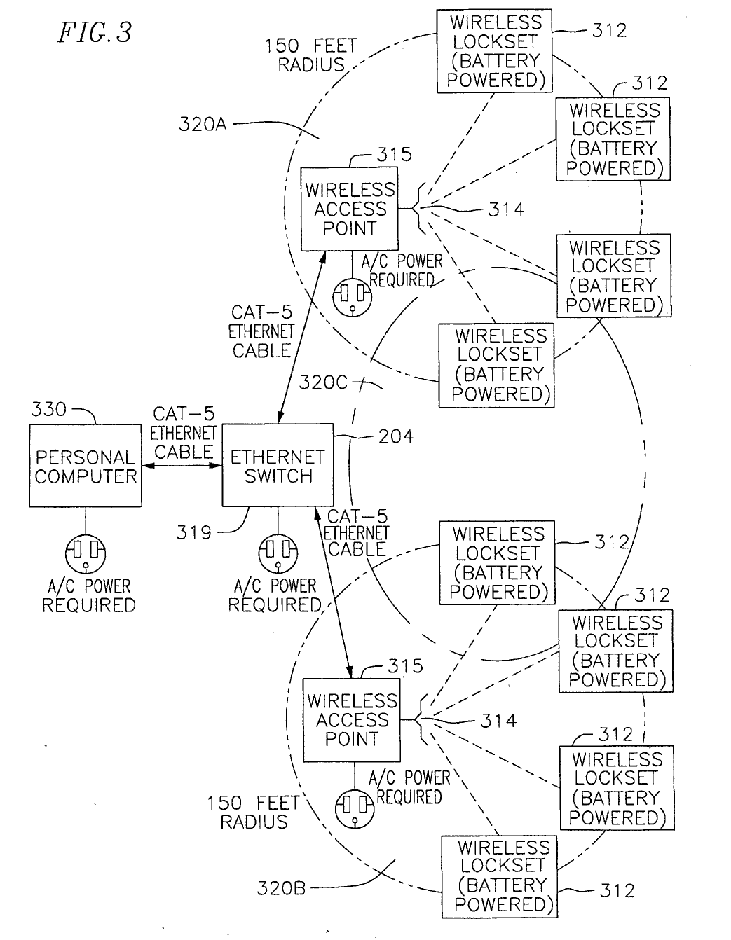

In more detail, FIG. 3 is a block diagram of a wireless access control system according to an embodiment of the present invention. The wireless access control system includes a plurality of wireless access points 315 and a switch 319. Each of the wireless access points 315 is for wirelessly connecting to one or more wireless devices 312, for example, one or more wireless locksets. Exemplary embodiments of locksets that can be used as the wireless devices 312 of FIG. 3 will be described in more detail below.

In addition, to provide additional security, a wireless device 312 includes an identity code that uniquely identifies the wireless device 312 to the wireless access points 315.

Each wireless access point 315 includes a wireless transceiver 314 that defines a geographical coverage area. In some embodiments of the present invention, the wireless access points 315 handle radio-channel setup and frequency hopping to provide further security.

The switch 319 acts like a normal switching node, and can additionally provide all the functionality needed to handle wireless access points 315.

As discussed above, in some embodiments of the present invention, one access point 315 is identified as the master and the others as slaves. That is, an operator, via the browser, can communicate with the master only. The master downloads the access control database files to the slaves through an Ethernet switch 319 as depicted in FIG. 3. The slaves send all lockset door actions and cardholder transactions received from their communicating wireless locksets 312 to the master access point.

With reference to FIG. 3, coverage areas 320A, 320B are shown for the two shown wireless access points 315 as solid circles. Also shown in FIG. 3 is a third coverage area 320C, shown as a dashed circle. The dashed coverage area 320C is for a third access point (not shown) whose coverage area overlaps the coverage areas of the shown access points such that some wireless devices 312 are within the coverage areas of two or more access points 315. When this occurs, the system coordinates and identifies, for each of the wireless devices 312 within the coverage areas of two or more access points 315, which of the access points 315 will communicate with the wireless device 312. It should be recognized that although in the present discussion, the first, second, and third coverage areas partially overlap with each other, in many implementations, there may be a number of wireless access points with coverage areas that do not overlap with the coverage areas of any other wireless access points.

The determination of which wireless access point 315 should be the master is initiated and/or controlled by either the wireless device 312 or the access points 315. In some embodiments of the present invention, the access points 315 automatically compensate for changes in the wireless environment by sampling the signal strength from each wireless device 312. That is, if two access points 315 are receiving signals from the same wireless device 312, the access point 315 receiving the stronger signal is determined to be the primary access point for the wireless device 312 and that access point makes it a part of its wireless device list (e.g., its lockset list) and informs the other access point 315 of its action.

Alternatively, in other embodiments of the present invention, the wireless device 312 scans the broadcast control channels of a plurality of neighboring wireless access points 315, and forms a list of best access point candidates for being a possible primary access point, based on the received signal strength. This information may be periodically passed back to the wireless access points 315 to determine when a handover should take place.

In some situations, though, the access point 315 that has the strongest signal with a particular wireless device 312 may not result in the fastest response to the wireless device 312 if the access point 315 with the strongest signal is the primary access point for many more wireless devices 312 than another access point 315 that has only a slightly weaker signal to the wireless device 312. Accordingly, in some embodiments, the system (e.g., the coordination computer 330 or the master access point), evaluates not only the signal strength of the connections between access points 315 and wireless devices 312, but also the load on the different access points 315 in determining which access point 315 should be the primary access point for each wireless device 312. As the load on different access points may fluctuate more than the wireless signal, changes to primary access points may be more frequent in this embodiment.

In some embodiments, the determination of which access point 315 to connect to is determined by the wireless device 312. In some embodiments, rather than making a choice between several access points as to which access point to connect to, the wireless device simply connects to the first access point that it finds when searching for wireless signals from access points. If the wireless device cannot connect to this access point, or if it loses it connection to the access point, the wireless device searches for another access point and repeats the process by connecting to the first access point that is then finds.

In addition, in some embodiments of the present invention, the wireless device 312 is a mobile device (e.g., a proximity reader or an RFID reader) that can be moved from one geographical area to another geographical area. As such, in this embodiment, the wireless access points 315 also handle handovers of wireless access points 315 as the mobile device 312 moves from one access point's coverage area (e.g., 320A) to another access point's coverage area (e.g., 320B).

The fact that the entire area covered by the wireless access control system is divided into coverage areas (e.g., 320A, 320B, 320C) (as defined by transceivers 314) necessitates an implementation of a handover (or handoff) mechanism.

Specifically, in the context of the present application, a handover (or handoff) mechanism is a mechanism for switching an ongoing communication session on a mobile device (e.g., wireless device 312) from one access point (e.g., access point 315) to another access point.

Handovers can be initiated and/or controlled by either the mobile device or the wireless access points 315 (as a means of traffic load balancing).

In some embodiments, the mobile device (e.g., wireless device 312) scans the broadcast control channels of a plurality of neighboring wireless access points 315, and forms a list of best access point candidates for possible handover, based on the received signal strength. This information may be periodically passed back to the wireless access points 315 to determine when a handover should take place. There are two methods used to determine when a handover should take place. One method sets a minimum acceptable performance level and gives precedence to power control over handover control. That is, when the signal degrades beyond a certain level, the power level of the mobile device is increased first. If further power increases do not improve the signal, then a handover is made. The other method uses handover first to try to maintain or improve a certain level of signal quality at the same or lower power level. Thus, this method gives precedence to handover control over power control.

In addition, regardless of whether the wireless device 312 is a mobile device or a fixed device (e.g., a door lock), a handover technique (whether initiated and/or controlled by either the mobile device 312 or the wireless access points 315) is used to determine which should be the secondary wireless access point 315 in case the primary access point 315 fails or otherwise loses its connection to the wireless device 312.

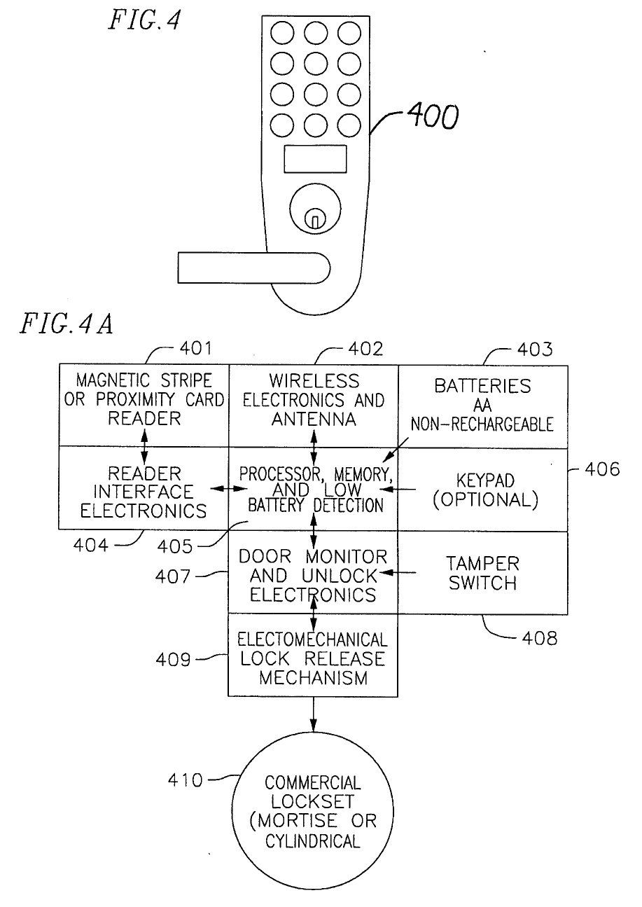

In reference to FIG. 4, in some embodiments of the present invention, the wireless lockset is a self-contained battery-operated assembly 400 that will mount on a door with standard mortise or cylindrical lock cutouts. The assembly does not require any additional drilling or modifications to the door for mounting and no wires or other physical connections are required outside the assembly. In some embodiments, the wireless assembly can have a portion of the unit on the secure side of the door as long as it does not require any modifications to the existing door cutouts. A block diagram of the various components of a wireless lockset 400 according to some embodiments of the invention is shown in FIG. 4A.

The various elements for a fully functioning wireless lockset are described in more detail below.

Commercial locksets are available from a myriad of manufacturers. The design of the wireless lockset can be based on purchasing suitable locksets 410 from one or more manufacturers.

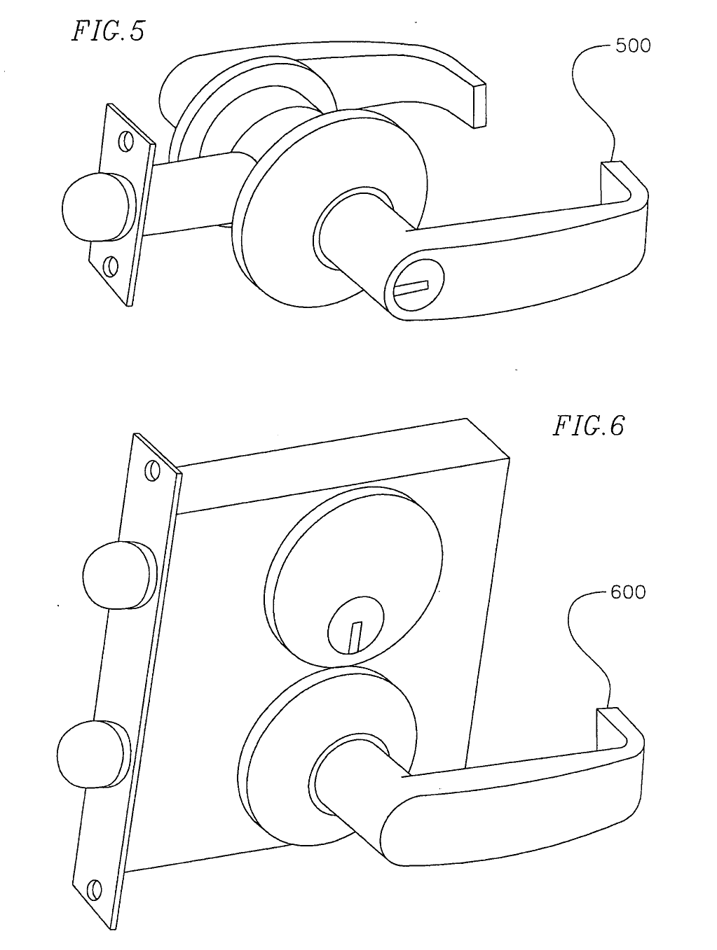

Commercial locksets are typically provided in two basic configurations: cylindrical locksets (where the lockset is inserted in a cylindrical hole through the door) (see, for example, lockset 500 in FIG. 5) and mortise locksets (where the lockset is inserted in a hole cut into or mortised in the edge of the door) (see, for example, lockset 600 in FIG. 6).

In secure areas doors are locked on the unsecured side (the handle will not move) and unlocked on the secure side (turning the handle allows the door to open providing free egress). Access is gained by the use of a key to unlock the door. Returning to FIG. 4A, the wireless lockset provides an electromechanical mechanism 409 to unlock the door. In existing card reader controlled locksets this is accomplished by a low power solenoid or by a spring and a miniature motor (e.g., a motor used with electronically controlled model airplanes). Typically, the goal is to select the method that consumes the least amount of power, thereby maximizing life of battery 403.

The door monitor and unlock electronics 407 detect and report that:
1) the locking mechanism is “unlocked” or “locked”;
2) the door is “open (ajar)” or “closed”;
3) the latching mechanism is “extended” or “retracted”; and/or
4) the housing tamper switch is “open” or “closed”.

This module controls the release of the locking mechanism. Relocking of the mechanism may be programmed by the user to:
1) relock when door is opened, or
2) relock at the end of an unlock time.

A switch 408 or some other technique is provided to detect when the wireless lockset housing is being opened or tampered with. An access point message is created indicating this breach.

The lockset can accommodate a reader 401 such as a magnetic stripe card reader, smart card reader or a proximity card reader. Magnetic stripe reader cartridges are available from manufacturers specifically for integrating into an original equipment manufacturer's (OEM) product. They are available as swipe or insertion readers. Smart card readers are similarly available. A proximity card, such as RFID cards, can be a “proximity reader on a chip” for use by OEMs.

The processor and memory 405 provide the control center for the wireless lockset. The processor interfaces with the other elements of the wireless lockset to coordinate each operation. In many embodiments, reader 401 is connected to processor and memory 405 through reader interface 404. Processor and memory 405 are connected to wireless electronics and antenna 402 to communicate wirelessly with other wireless components of the system, such as wireless access points. In some embodiments, all or some of the wireless electronics are included in the processor and memory 405. In some embodiments, such as the wireless lockset 400, a keypad 406 is connected to the processor and memory 405

The lockset should have sufficient memory capacity to store the access information from the access control database (e.g., card number, PIN, time access privileges) for a plurality of cards requiring access to the door. The lockset makes the access decision for a card presented to the lockset based on the access information stored in the lockset memory for that card. In some embodiments, the data for all cards in the system is initially downloaded in bulk from the primary access point for the lockset. The same bulk download is performed for each of the locksets in the entire system. Accordingly, in this system architecture, the access control database, or at least substantial portions of it, resides simultaneously at the coordination computer, the access points and the wireless locksets. In this system, the lockset does not communicate with the access point after each access decision (e.g., card swipe), but rather only communicates at periodic intervals. During the periodic communications, the transaction history since the last communication is uploaded to the access point and updates to the access control database or other system information may be downloaded to the lockset.

This system architecture has several advantages. First, it reduces power consumption by the lockset because the lockset does not turn on its wireless transceiver when it makes access decisions based on the access control database entries stored in its memory. This is of particular importance because the typical lockset is a battery powered wireless lockset. Second, because the locksets generally only communicate with the access points for the periodic communication, the load on both the access point's wireless network bandwidth and the access point's processor are reduced. Last, the lockset can make an access decision faster because its processor makes the access decision rather than forwarding an access decision request to an access point and wait for the access point to return an access decision command to the lockset.

In general, as discussed above, the access control database is simultaneously located in three separate areas of the system: a central computer (or network of computers), the wireless access points, and the local wireless devices such as the wireless locksets. In some embodiments, the entire access control database is not stored together in any of the access points, but collectively the access points contain the entire access control database and each individual access point contains the entire portion of the access control database needed for all of the access control devices communicating with that access point. In many of these embodiments, though, the access points have information regarding what portions of the access control database is located on other access points and an identification or pointer to the access points that store these portions of the access control database. In other embodiments, each access point or at least one access point contains the entire access control database. Similarly, in some embodiments, the entire access control database is not stored together in any of the individual access control devices (e.g., a wireless lockset), but collectively the various access control devices contain the entire access control database and each individual access control device contains the portion of the access control database needed for the decisions that need to be made by the access control devices. In other embodiments, each access control device or at least one access control device contains the entire access control database.

A feature of this three tiered database architecture (central computer or network, access points, and access control devices) is that any of the tiers can operate without compromise independently even if one or both of the other tiers is not operational of losses communication with one or both of the other tiers. One example of many instances of losses of communication is in the case of a loss of power by either the central computer or one or more of the wireless access points.

One situation that can result from this architecture is that at a particular moment, an update may have been made to the access control database that has not been downloaded yet to the lockset. At such a moment, an individual that has recently been given access for a lockset may request access from the lockset and the individual (or their card) is not in the lockset's access control information or the access control information in the lockset for the individual has not been updated. In some embodiments in such cases, the lockset immediately sends an access control information update request for the new individual. The access point, when it receives such a request, immediately checks its access control database and, if it has updated information in the access control database, sends the access control information for the individual to the lockset. The lockset will then update its access control information with the access control information sent by the access point and makes an access decision in the same way as if the lockset had not had to update the access control information. If updated access control information for the new individual was not in the access point, the lockset would process the access request based on the access control information it has (e.g., deny access in this example).

In other embodiments in such cases, the lockset immediately sends an access decision request to the access point and waits for a response. The access point, when it receives such a request, immediately checks its access control database and sends an access control decision to the lockset, which unlocks or does not unlock the lockset according to the received access control decision. At this point, as is discussed in more detail below, the access point will transmit to the lockset the current access control database information for the individual that has just sought access from the lockset. However, it is noted that this update to the lockset access control information is done after the lockset has resolved the individual's access request and as a separate transaction from to the access request process. This alternate embodiment allows for faster response to the access request by the lockset, but requires more wireless transmissions using more bandwidth and battery power.

In many embodiments, the wireless locksets and any other battery powered device in the system can monitor their battery power. If a device monitors that its battery power is below a certain level, it immediately sends a signal to an access point, which relays the warning to the central computer or network so that a system operator is notified and action can be taken.

As illustrated in the preceding scenario, in the distributed access control database architecture, the access control information stored in individual lockset must be periodically updated. This is accomplished by the locksets having a “learn mode.” As discussed above, in some embodiments, the access control database is initially downloaded in bulk to each of the locksets. In an alternate embodiment, only a portion of the access control database is downloaded or stored in the lockset, based on the likelihood that particular access control information will be needed by that lockset. In still other embodiments, initially the lockset has no access control information (card information) stored in its memory.

In some embodiments, when a card is first presented to the lockset's reader or a card is presented to the lockset's reader that is not in the access control information stored in the lockset's memory, the lockset sends the card's number and PIN entry, if required, to the wireless access point. The access point searches its memory to see if that card is authorized for access at this lockset at this time. The access point then returns to the lockset a “Grant Access” or “Deny Access” response along with all access information for that card. After the access point returns the “Grant Access” or “Deny Access” response to the lockset, giving the lockset enough time to act on the access response, the access point sends a separate communication to the lockset with the access control information for the card. In some embodiments, the access decision response and access control information for the card are sent in the same communication to the lockset. The lockset stores the access control information for this card data so that it can make all future access decisions for that card. With this method a lockset populates its memory with new card data each time a “first time” card is presented. In the embodiment where locksets initially have no access control information stored in memory, the memory contains card data for only those cards that “need” to have access and not data for cards that have access but have never appeared. Card modifications and deletions would be made via individual transmissions as required.

In some embodiments, when a card is first presented to the lockset's reader or a card is presented to the lockset's reader that is not in the access control information stored in the lockset's memory, the lockset sends the card's number to a wireless access point. The access point searches its memory to see if it has access control information for that card. If it does, it sends the information to the lockset. The lockset stores the access control information for this card and makes an immediate access decision. The access control information is then used for future access decisions for that card until the access control information is updated as described above with respect to various other embodiments. In some embodiments,

The Learn Mode described above offers the lockset the ability to appear to accommodate more cards than the memory can hold. If the lockset card memory is full to capacity (e.g., 5000 cards, but this number can vary based on the amount of memory installed in the lockset) and a “first time” card is presented, the learning process, as described above, will follow. In this case, the lockset grants or denies access as instructed by the access point but ignores the card data since there is no place to store it. This card will remain a “first time” card and the access point will continue to make the access decisions for this and any other “first time” cards until the lockset card memory is below full capacity.

In an alternate embodiment, when an individual seeks access from a lockset and the access control information stored in the lockset's memory results in an access denial, the lockset still sends the card's number and PIN entry, if required, to the wireless access point to confirm the denial of access. This is done because the access control information for the individual stored in the lockset memory may be out of date and more current information in the access point would allow entry. In another alternative, the lockset does not send an access request to the access point when its local access control information indicates a denial of entry until access has been requested and denied for an individual a predetermined number of times.

Another way to handle the memory-full situation or otherwise reduce the size of the access control information stored in a lockset is by means of a “least recently used” method. For example, when the lockset receives data for a “first time” card it locates a card stored in the card file memory that has not been used for a long time—“least recently used”. The data for this card is deleted and is replaced with the data for the current card. The “old” card becomes a “first time” card the next time it appears at the lockset.

A “fallback” access control method may be employed when a lockset temporarily loses transmission with the wireless access point and is unable to receive data on a “first time” card. When the lockset senses that it has lost communications with the access point it can be instructed to read only a prearranged subset of characters, e.g., a facility code, from “first time” cards. This facility code is identical on all cards for a facility. So, during lost communications, the lockset will grant access to any “first time” card that has the system's facility code. In some embodiments, a facility uses a number of facility codes. In an alternative embodiment, the lockset can be programmed with multiple (e.g., 8) facility codes, so that the cards of related facilities will also operate the lockset in this manner.

In certain circumstances, it may be desired to have a particular lockset remain unlocked for a period of time beyond the time needed for one entry. In the case of locksets that are not battery powered, this is not a terribly important issue. For a battery powered lockset, however, powering a unlocking solenoid for an extended period of time will quickly drain the battery. To accommodate such situations, the battery powered lockset is equipped with a latching solenoid. The latching solenoid does not have a “default” state that it automatically goes into when power is not supplied, but rather may remain in either the locked or unlocked position without application of power. In the latching solenoid, the application of power switches the lockset between the locked and unlocked state and power does not need to be applied to the solenoid to maintain the lockset in either the locked or unlocked states.

As each card transaction is processed a “card transaction message” (what card was granted/denied access and time of transaction) can be stored in local transaction memory and transmitted, on request, to the wireless access point for reporting purposes. This same memory can also store all other events that have occurred unrelated to card transactions. The lockset memory can store a plurality of transactions. The lockset processor can send a message to the access point indicating when the transaction memory becomes 80% full. This can cause the access point to request the transactions from the lockset.

In some embodiments, the wireless electronics and antenna are made to be an integral part of the wireless lockset.

Any suitable batteries (e.g., AA size batteries) can be used as the power source for the wireless lockset. In some embodiments, the batteries for the wireless lockset provide sufficient power for approximately 500,000 unlocking operations. The number of batteries required will be established during the design phase.

A battery compartment door on the lockset, secured by a security screw, provides a method for replacing (changing) the batteries without removing the lockset from the door. A switch or some other technique is provided to detect when the battery compartment door has been opened or the battery compartment has been removed. An battery tamper message is created indicating this breach.

The basic design concept for the wireless lockset offers the ability to provide two ancillary products that will expand the functionality of the basic system with minimal additional design effort. Each of these is described below.

There may be portal installations where a lockset simply will not work—glass doors, turnstiles, pedestrian and vehicle gates. Or a facility may already have some doors equipped with a card reader and an electric strike or electromagnetic lock. In these cases a wireless portal controller can be used.

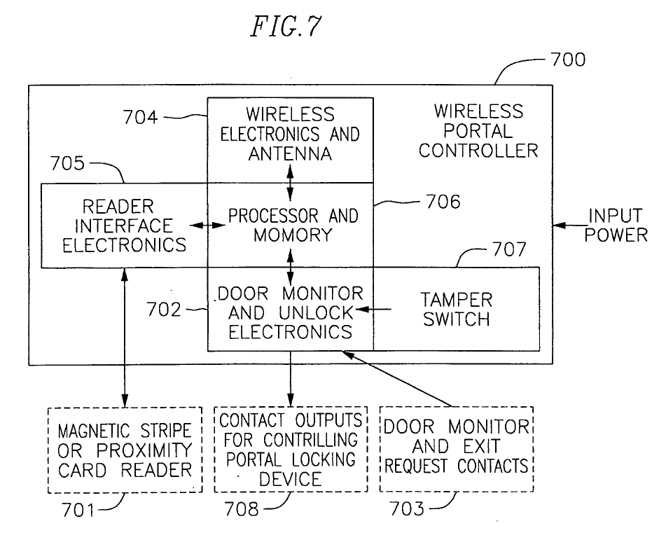

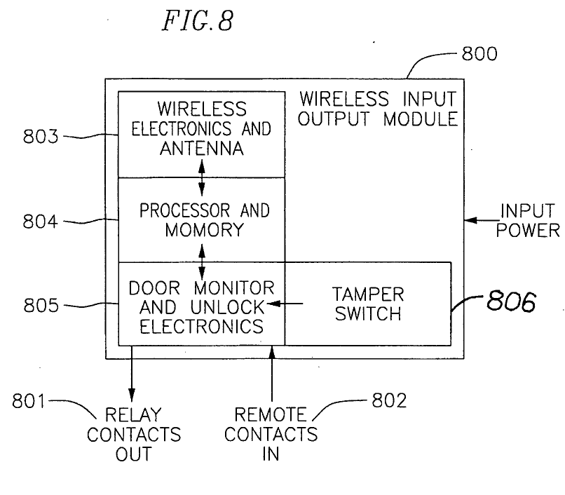

With reference to FIG. 7, the wireless portal controller 700 can be composed of a subset of components from the wireless lockset. The reader 701 is now an external device; however, it still provides the same electrical signals as the reader modules described above. The reader 701 connects to the processor and memory 706 through reader interface electronics 705. Wireless electronics and antenna 704 and tamper switch 707 similar to wireless electronics and antenna 402 and switch 408 are also included. The commercial lockset and the electromechanical lock release mechanism have been removed.

Unlocking of the portal is controlled by a set of relay contacts 708 provided by the door monitor and unlock electronics 702. When the portal is to be unlocked these contacts merely provide a closed circuit (or open circuit depending on the design of the external locking device) with an external source of power to the external locking device.

The door monitor and exit request functions are external contact closures 703 similar to commercial lockset contacts.

The controller 700 can be housed in a simple electronic enclosure with no limiting size restrictions. Since the external reader 701 and portal locking device require power to operate, the rechargeable batteries can be eliminated and replaced with an external power source 709.

There are occasions where there is a need to monitor or control a device that is not associated with a portal with a card reader. An example is an emergency fire exit. Typically these are doors that are always locked and have “panic hardware” (a push bar) that unlocks the door from the inside to allow free egress in case of an emergency. If this door is provided with a set of monitor contacts they can be wired to a wireless input/output module 800 as shown in FIG. 8. This module would report to the wireless access point when this door has been opened and closed.

In other cases there may be other doors that are normally locked to the outside but people may freely exit at any time. There may be times when this door needs to be unlocked. The wireless input/output module 800 can provide a set of relay contacts 801 that would provide a closed circuit (or open circuit depending on the design of the external locking device) between an external power source and the door locking device. This same module could also monitor the “open” and “closed” state of the door by means of door monitor contacts mounted on the door.

Since there are no requirements for interfacing to a reader, the wireless input/output module is an even simpler module than the portal controller 700. In other respects, processor and memory 804, wireless electronics and antenna 803, and tamper switch 806 are similar to their respective components in portal controller 700.

In typical embodiments, at a minimum the module 800 has two sets of relay contacts 801 and accommodates two sets of remote contact closures 802, connected to processor and memory 804 through output relays and contact monitors 805. In many embodiments four (4) sets of each or more are included.

The input/output module 800 can be housed in the same electronic enclosure used for the portal controller 700. The rechargeable batteries can be eliminated and replaced with an external power source.

While the present invention has been described in connection with certain exemplary embodiments, it is to be understood that the invention is not limited to the disclosed embodiments, but, on the contrary, is intended to cover various modifications and equivalent arrangements included within the spirit and scope of the appended claims, and equivalents thereof.

What is claimed is:

1. A wireless access control system comprising:
an access control computer system;
a plurality of wireless access points communicatively connected to the access control computer system including a first wireless access point comprising a first wireless transceiver and a second wireless access point comprising a second wireless transceiver, the first wireless transceiver adapted to define a first coverage area and the second wireless transceiver adapted to define a second coverage area; and
a wireless access control device controller located within the first coverage area and the second coverage area and having an identity code adapted to uniquely and wirelessly identify the wireless access control device controller to the plurality of wireless access points, wherein the wireless access control device controller is configured to:
communicate wirelessly to the first wireless access point and the second wireless access point, to rate the quality of the connection to the access control computer system and the plurality of wireless access points using each of the first and second wireless access points, and
download access control information from the first wireless access point or the second wireless access point based on the connection quality ratings.

2. The system of claim 1, wherein the wireless access control device controller is not in a fixed location and is movable within and without the first and second coverage areas.

3. The system of claim 1, further comprising a wireless lockset that comprises the wireless access control device controller.

4. The system of claim 3, wherein the wireless lockset is a self-contained battery-operated assembly adapted to be mounted to a door.

5. The system of claim 4, wherein the self-contained battery-operated assembly comprises a latching solenoid adapted to remain in one of a locked position or an unlocked position in an unpowered state.

6. The system of claim 3, wherein the wireless lockset comprises at least one of the group of: a magnetic stripe card reader, a smart card reader, and a proximity card reader.

7. The system of claim 1, wherein the wireless access control device controller is a wireless portal controller coupled with at least one of the group of: an external magnetic stripe card reader, and an external proximity card reader.

8. The system of claim 1, wherein the wireless access control device controller is connected to a wireless input/output module coupled with a plurality of monitor contacts of a door, the wireless input/out module being adapted to notify one of the wireless access points upon closing and opening of the door.

9. An access control system comprising:
an access control computer system comprising a central database of information for making access control decisions;
at least one wireless access point including a WAP database of information for making access control decisions and communicatively connected to the access control computer system, wherein the information for making access control decisions in the WAP database is a proper subset of the information for making access control decisions in the central database; and
a plurality of wireless access control device controllers, each including a controller database of information for making access control decisions and each wirelessly communicatively connected, at least occasionally, to at least one wireless access point;
wherein the plurality of wireless access control device controllers includes a plurality of first wireless access control devices, wherein the information for making access control decisions in the controller database of each of the first wireless access control device controllers is a proper subset of the information for making access control decisions in the WAP database of at least one wireless access point wirelessly communicatively connected, at least occasionally, to such first wireless access controller.

10. The system of claim 9, further comprising a plurality of wireless locksets, each comprising at least one of the plurality of wireless access control device controllers.

11. The system of claim 10, wherein a plurality of the wireless locksets are self-contained battery-operated assemblies adapted to be mounted to a door.

12. The system of claim 10, wherein a plurality of the self-contained battery-operated assemblies comprises a latching solenoid adapted to remain in one of a locked position or an unlocked position in an unpowered state.

13. The system of claim 10, wherein a plurality of the wireless locksets comprises at least one of the group of: a magnetic stripe card reader, a smart card reader, and a proximity card reader.

14. The system of claim 9, wherein a plurality of the wireless access control device controllers are wireless portal controllers coupled to at least one of the group of: an external magnetic stripe card reader, and an external proximity card reader.

15. The system of claim 9, wherein a plurality of the wireless access control device controllers are connected to a wireless input/output module coupled with a plurality of monitor contacts of a door, the wireless input/out module being adapted to notify one of the wireless access points upon closing and opening of the door.

16. An access control device controller comprising:
a memory storing a database of access control information;
an input;
a wireless transceiver that communicates with a central access control system; and
a connection with an access control device;
wherein the access control device controller is configured to:
receive an access request from the input;
determine an access control decision for the access request using the database of access control information when the database of access control information includes information sufficient to make an access control decision for the access request,
transmit at least a portion of the access request to the central access control system using the wireless transceiver when the database of access control information does not include information sufficient to make an access control decision for the access request and then receive an access control decision for the access request from the central access control system; and
supply an access control signal to the access control device based on the access control decision for the access request.

17. The access control device controller of claim 16 wherein the access control device controller is further configured to add information from the access request and the access control decision to the database of access control information when the database of access control information does not include information sufficient to make an access control decision for the access request when the access request is received.

18. The access control device controller of claim 17 wherein the access control device controller is further configured to remove information from the database of access control information when information is added to the database of access control information from the access request and the access control decision and the size of the database of access control information exceeds a predetermined size.

19. The access control device controller of claim 16 wherein the access control device controller is further configured to:
determine a special access control decision for the access request using the database of access control information when the access control device controller is not able to transmit the at least a portion of the access request to the central access control system or an access control decision is not received from the central access control system within a predetermined length of time after the at least a portion of the access request is transmitted to the central access control system using the wireless transceiver; and
when a special access control decision is determined, supplying the access control signal to the access control device based on the special access control decision for the access request rather than based on the access control decision for the access request.

20. A method for operating a wireless access control system including: a switch; a plurality of wireless access points coupled to the switch and including a first wireless access point including a first wireless transceiver and a second wireless access point including a second wireless transceiver, the first wireless transceiver adapted to define a first coverage area, and the second wireless transceiver adapted to define a second coverage area overlapping a portion of the first coverage area; and a wireless device located within the overlapped portion of the first coverage area and having an identity code adapted to uniquely and wirelessly identify the wireless device to the plurality of wireless access points, the method comprising:
receiving at the first wireless access point a first signal from the wireless device;
receiving at the second wireless access point a second signal from the wireless device;
measuring at the first wireless access point a first signal strength of the first signal;
measuring at the second wireless access point a second signal strength of the second signal;
sending the first signal strength by the first wireless access point to the second wireless access point;
sending the second signal strength by the second wireless access point to the first wireless access point;
determining at the first wireless access point and the second wireless access point a stronger signal strength of the first signal strength and the second signal strength;
selecting, if the first signal strength is determined to be the stronger signal strength, the first wireless access point as a primary access point corresponding to the wireless device; and
selecting, if the second signal strength is determined to be the stronger signal strength, the second wireless access point as a primary access point corresponding to the wireless device.

21. The method of claim 20, wherein the wireless device is a wireless lockset.

22. A method for operating a wireless access control system including: a switch; a plurality of wireless access points coupled to the switch and including a first wireless access point including a first wireless transceiver and a second wireless access point including a second wireless transceiver, the first wireless transceiver adapted to define a first coverage area, and the second wireless transceiver adapted to define a second coverage area overlapping a portion of the first coverage area; and a wireless device located within the overlapped portion of the first coverage area and having an identity code adapted to uniquely and wirelessly identify the wireless device to the plurality of wireless access points, the method comprising:
receiving at the wireless device a first signal from the first wireless access point;
receiving at the wireless device a second signal from the second wireless access point;
measuring at the wireless device a first signal strength of the first signal;
measuring at the wireless device a second signal strength of the second signal;
determining at the wireless device a stronger signal strength of the first signal strength and the second signal strength;
selecting, if the first signal strength is determined to be the stronger signal strength, the first wireless access point as a primary access point corresponding to the wireless device; and
selecting, if the second signal strength is determined to be the stronger signal strength, the second wireless access point as a primary access point corresponding to the wireless device.

23. The method of claim 22, wherein the wireless device is a wireless lockset.

24. An access control system comprising:
an access control computer system comprising a central database of information for making access control decisions;
a wireless access point, including a WAP database of information for making access control decisions;
a first communication link communicatively connecting the wireless access point to the control computer system allowing transfer of information between the central database and the WAP database;
a plurality of wireless access control device controllers, each including a controller database of information for making access control decisions; and
a plurality of second communication links, each communicatively connecting one of the wireless access control devices controllers to the wireless access point allowing transfer of information between the WAP database and the controller database of the one of the wireless access control devices controllers;
wherein the plurality of wireless access control device controllers are configured to, when their second communication link is functional and when their second communication link is not functional, make access control decisions;
wherein the wireless access point is configured to, when the first communication link is functional and when the first communication link is not functional:
receive access control requests from the wireless access control device controllers and return access control decisions using one of the second communication links; and
transfer information between the WAP database and the controller databases.
